(19) United States
(12) Patent Application Publication
(10) Pub. No.: US 2009/0124719 A1
(43) Pub. Date: May 14, 2009

(54) POLYURETHANE FOAMS FROM POLYTRIMETHYLENE ETHER GLYCOL

(75) Inventors: Joseph Anthony Creazzo, Wilmington, DE (US); Gary Loh, Newark, DE (US); Hari Babu Sunkara, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DUPONT DE NEMOURS AND COMPANY, Wilmington, DE (US)

(21) Appl. No.: 12/266,030

(22) Filed: Nov. 6, 2008

Related U.S. Application Data
(60) Provisional application No. 60/986,541, filed on Nov. 8, 2007.

(51) Int. Cl. C08J 9/228

(52) U.S. Cl. 521/137

(57) ABSTRACT

Provided are polyurethane foams containing polytrimethylene ether segments derived from polytrimethylene ether glycols.

### FIELD OF THE INVENTION

This invention relates to polyurethane foams containing polytrimethylene ether segments derived from polytrimethylene ether glycols.

### BACKGROUND

Closed-cell polyisocyanate-based foams are widely used for insulation purposes, for example, in building construction and in the manufacture of energy efficient electrical appliances. In the construction industry, polyurethane (polyisocyanurate) board stock is used in roofing and siding for its insulation and load-carrying capabilities Poured and sprayed polyurethane foams are widely used for a variety of applications including insulating roofs, insulating large structures such as storage tanks, insulating appliances such as refrigerators and freezers, insulating refrigerated trucks and railcars, etc.

Polyurethane foams are conventionally produced by mixing an isocyanate component, a polyol component and a blowing agent.

All of these various types of polyurethane foams require blowing (expansion) agents for their manufacture. Insulating foams depend on the use of halocarbon blowing agents, not only to foam the polymer, but primarily for their low vapor thermal conductivity, a very important characteristic for insulation value. Historically, polyurethane foams used CFCs (chlorofluorocarbons, for example CFC-11, trichlorofluoromethane) and HCFCs (hydrochlorofluorocarbons, for example HCFC-141b, 1,1-dichloro-1-fluoroethane) as the primary blowing agent.

Commercially-available polyurethane foams currently are generally produced using polyether diols, polyols derived from polymerization of ethylene oxide and propylene oxide, polyester polyols, vegetable oil-based polyols, and blends of two or more thereof. While the polyurethane foams prepared using these raw materials exhibit useful properties, they suffer from the fact that the starting materials are petroleum based and not available from renewable sources.

Polyols derived from seed/vegetable oils, and polyurethane foams prepared therefrom, have been described in the literature (see, for example, WO2004096882 and U.S. Pat. No. 4,543,369). However, there remains a need for environmentally friendly polyurethane foam compositions, and foams comprising renewable sourced polyols.

U.S. Pat. No. 6,946,539 and US 2007/0129524A1 disclose polyurethanes prepared using a polytrimethylene ether glycol. Polytrimethylene ether glycol is readily prepared by polycondensation of 1,3-propanediol (and optionally other glycols such as ethylene glycol) which, as previously disclosed in U.S. Pat. No. 5,633,362, U.S. Pat. No. 5,686,276 and U.S. Pat. No. 5,821,092, may be prepared by a fermentation process using a renewable biological source.

It is desirable to have good quality and economical polyurethane foams at least in part based on a consistent quality, renewable biological starting polyol component. The present invention is directed to these and other important ends.

### SUMMARY OF THE INVENTION

One aspect of the present invention is a polyurethane foam comprising the reaction product of ingredients comprising:
(a) An isocyanate-reactive compound comprising a polytrimethylene ether glycol,
(b) a polyisocyanate component comprising an isocyanate having an average functionality of at least 2, and
(c) a blowing agent.

In one embodiment, the polyurethane foams are made from polyols that are derived from a petroleum-free source.

### DETAILED DESCRIPTION

The present invention provides foams, particularly closed-cell polyurethane foams, suitable for applications such as insulation. The inventors have surprisingly found that rigid foams having desirable properties for insulation, such as good cell structure, dimensional stability, and an insulating R-value comparable to conventional insulating foams, can be made using polytrimethylene ether glycol, which is a flexible molecule and has primary hydroxyls with a functionality of 2. This type of polyol would not typically be considered for such foams because of their functionality and molecular weights. In particular, it has been discovered that closed-cell foams having properties comparable to conventionally-made rigid foams can be obtained according to the present invention.

“Closed-cell foams” means foams having cells of which at least about 90% are not ruptured or otherwise opened/

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present and B is true (or present), and both A and B is true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting. Although methods and materials similar or equivalent to those described herein can be used in the practice or testing of the present invention, suitable methods and materials are described herein.

In the context of the present invention the following terms have the following meaning.

(1) The isocyanate index is the ratio of NCO-groups over isocyanate-reactive hydrogen atoms present in the foam ingredients, presented as a percentage, i.e.:

Isocyanate Index=([NCO]×100)/[active hydrogen]

Thus the isocyanate index expresses the percentage of isocyanate actually used in a formulation with respect to the amount of isocyanate theoretically required for reacting with the amount of isocyanate-reactive hydrogen used in the formulation. The isocyanate index as used herein is considered from the point of view of the foaming process involving the isocyanate ingredients and the isocyanate-reactive ingredients.

(2) The expression “isocyanate-reactive hydrogen atoms” as used herein for the purpose of calculating the isocyanate index refers to the total of active hydrogen atoms in hydroxyl and other functional groups (such as amine groups) present in the reactive compositions. For the purpose of calculating the isocyanate index at the actual foaming process one hydroxyl group is considered to comprise one reactive hydrogen, one primary amine group is considered to comprise one reactive hydrogen and one water molecule is considered to comprise two active hydrogens.

(3) The expression “polyurethane foam” as used herein refers to cellular products as obtained by reacting di- or polyisocyanates with isocyanate-reactive hydrogen containing compounds such as polyols, aminoalcohols and/or polyamines, using blowing agents, such as fluorocarbons, fluoroolefins, hydrocarbons, chlorocarbons, acetone, methyl formate, and CO₂ generated in situ by reaction of the polyisocyanate with water added to the formulation. Polyisocyanurate foams, obtained when an excess of isocyanate is incorporated to react with itself, are also included in “polyurethane foams”.

(4) The term “average nominal hydroxyl functionality” is used herein to indicate the number average functionality (number of hydroxyl groups per molecule) of the polyol component or polyol composition on the assumption that this is the number average functionality (number of active hydrogen atoms per molecule) of the initiator(s) used in their preparation (although in practice it will often be somewhat less because of some terminal unsaturation or other functionalization).

(5) The word “average” refers to number average unless indicated otherwise.

(6) The term “cream time” refers to the time period starting from the mixing of the active hydrogen-containing compound with polyisocyanate, and ending when the foaming starts to occur and color of the mixture starts to change.

(7) The term “rise time” refers to the time period starting from the mixing of the active hydrogen-containing compound with polyisocyanate, and ending when the foam rising stops.

(8) The term “tack free time” refers to the time period starting from the mixing of the active hydrogen-containing compound with polyisocyanate, and ending when the surface of the foam is no longer tacky.

(9) The term “initial R-value” refers to the polymer foam's insulation value (thermal resistance) measured at a mean temperature of 75° F. within 24 hours after the foam is formed and becomes tack free.

The present invention is directed to polyurethane foams. The foams comprise the reaction product of ingredients comprising: (a) an isocyanate-reactive compound comprising a polytrimethylene ether glycol; (b) a polyisocyanate component comprising a di or polyisocyanate; and (c) a blowing agent.

The polyurethane foams are prepared by reacting the above ingredients.

In preferred embodiments, the isocyanate-reactive compound such as polyols, are derived from petroleum-free sources.

Preferably, the polytrimethylene ether glycol (PO3G) is made by polycondensation of 1,3-propanediol that is produced by a fermentation process using a renewable biological source.

Preferably the isocyanate index of the ingredients is from about 100 to about 400, more preferably from about 105 to about 350, although the isocyanate index can be about 500 or higher in some embodiments. Preferably, the average isocyanate-reactive functionality of the isocyanate-reactive compound comprising a polytrimethylene ether glycol, and/or the average isocyanate functionality of the polyisocyanate component comprising a di or polysocyanate, is greater than 2. An average isocyanate-reactive functionality greater than 2 can provide crosslinking in the resulting foam.

### Isocyanate-Reactive Compound

The isocyanate-reactive compound is characterized by an isocyanate index, which is one factor affecting the physical properties of the foam. The isocyanate index is the stoichiometric amount of isocyanate needed to react with the active hydrogen components in the isocyanate-reactive ingredients. An index of 100 indicates that the formulation contains stoichiometrically equal amounts of isocyanate and active hydrogen components in the isocyanate-reactive ingredients. Indexes less than 100 indicate that the formulation contains an excess amount of polyol, whereas indexes above 100 indicate that the formulation contains an excess amount of isocyanate. Thus, an isocyanate index of 102 means that the formulation contains 102 percent of the amount of isocyanate stoichiometrically required to react with all active hydrogen components in the polyol. The isocyanate-reactive compound comprises predominantly polyols e.g., at least about 50% polyols.

The isocyanate-reactive compound comprises a polytrimethylene ether glycol (“PO3G”). The amount of the PO3G can vary between 1 and 100 weight percent, based on the total weight of the isocyanate-reactive compound, depending on factors such as cost, intended end use, and desirable properties for the foam. More typically, the amount of the PO3G is from about 20 to about 80 weight percent, and in some preferred embodiments, about 40 to 60 weight percent. For some applications, the isocyanate-reactive compound can beat least about 50 wt % PO3G, at least about 75 wt % PO3G, or even at least about 90 wt % PO3G, based on the total weight of the isocyanate-reactive compound. PO3Gs have a functionality of 2; if it is desirable to increase the average functionality, the isocyanate-reactive compound can comprise a blend of PO3G with polyols having functionalities greater than 2. A preferred polyol for this purpose is one derived from a renewable resource, such as, for example,a seed oil or vegetable oil-based polyol. Suitable vegetable oil-based polyols include those derived from sunflower oil, canola oil, rapeseed oil, corn oil, olive oil, soybean oil, castor oil and mixtures thereof.

In one embodiment, the PO3G is blended with other oligomeric and/or polymeric polyfunctional isocyanate-reactive compounds such as, for example, polyether polyols (other than PO3G), polyester polyols, polyamines, polythiols, polythioamines, polyhydroxythiols and polyhydroxylamines. When blended, it is preferred to use predominantly tri and higher functional components and, more preferably, one or more polyols including, for example, polyether polyols polyester diols, polycarbonate diols, polyacrylate diols, polyolefin diols and silicone diols. One preferred blending component is a polyol derived from seed/vegetable oils.

In one embodiment, as discussed further below, it is also preferred to include tri- and higher-functional isocyanate-reactive compounds to impart some crosslinking/gel structure within the foam. Preferably the PO3G is blended with about 50 wt % or less, more preferably about 25 wt % or less, and even still more preferably about 10 wt % or less, of the other isocyanate-reactive compounds.

### Polytrimethylene Ether Glycol (PO3G)

Polytrimethylene ether glycol polymers in which at least 50% of the repeating units are trimethylene ether units. More preferably from about 75% to 100%, still more preferably from about 90% to 100%, and even more preferably from about 99% to 100%, of the repeating units are trimethylene ether units.

Polytrimethylene ether glycols are preferably prepared by polycondensation of monomers comprising 1,3-propanediol, thus resulting in polymers or copolymers containing —(CH₂CH₂CH₂O)— linkages (e.g, trimethylene ether repeating units). As indicated above, at least 50% of the repeating units are trimethylene ether units.

In addition to the trimethylene ether units, lesser amounts of other units, such as other polyalkylene ether repeating units, may be present. In the context of this disclosure, the term “polytrimethylene ether glycol” encompasses polytrimethylene ether glycol made from essentially pure 1,3-propanediol, as well as those polymers (including those described below) containing up to about 50% by weight of comonomers.

The 1,3-propanediol employed for preparing the polytrimethylene ether glycols may be obtained by any of the various well known chemical routes or by biochemical transformation routes. Preferably, the 1,3-propanediol is obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several patents, including U.S. Pat. No. 5,633,362, U.S. Pat. No. 5,686,276 and U.S. Pat. No. 5,821,092. For example, U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol contains only renewable carbon, and not fossil fuel-based or petroleum-based carbon. The polytrimethylene ether glycol and personal care compositions utilizing the biologically-derived 1,3-propanediol, therefore, may have less impact on the environment as the 1,3-propanediol used in the compositions does not deplete diminishing fossil fuels and, upon degradation, releases carbon back to the atmosphere for use by plants once again. Thus, the compositions disclosed herein can be characterized as more natural and having less environmental impact than similar compositions comprising petroleum based polyols.

Biologically-derived 1,3-propanediol, and compositions comprising biologically-derived 1,3-propanediol, therefore, may be distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as the reactant or as a component of the reactant will have a purity of greater than about 99%, and more preferably greater than about 99.9%, by weight as determined by gas chromatographic analysis. Particularly preferred are the purified 1,3-propanediols as disclosed in US20040260125A1, US20040225161A1 and US20050069997A1, and polytrimethylene ether glycol made therefrom as disclosed in US20050020805A1.

The 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

The starting material for making polytrimethylene ether glycol depends on the desired polytrimethylene ether glycol, availability of starting materials, catalysts, equipment, etc., and comprises “1,3-propanediol reactant.” By “1,3-propanediol reactant” is meant 1,3-propanediol, and oligomers and prepolymers of 1,3-propanediol preferably having a degree of polymerization of 2 to 9, and mixtures thereof. It may be desirable to use up to 10% or more of low molecular weight oligomers where they are available. Thus, preferably the starting material comprises 1,3-propanediol and the dimer and trimer thereof. A particularly preferred starting material comprises about 90% by weight or more 1,3-propanediol, and more preferably 99% by weight or more 1,3-propanediol, based on the weight of the 1,3-propanediol reactant.

Polytrimethylene ether glycol can be made via a number of processes known in the art, such as disclosed in U.S. Pat. No. 6,977,291 and U.S. Pat. No. 6,720,459.

As indicated above, polytrimethylene ether glycol may contain lesser amounts of other polyalkylene ether repeating units in addition to the trimethylene ether units. The monomers for use in preparing polytrimethylene ether glycol can, therefore, contain up to 50% by weight, preferably about 20 wt % or less, more preferably about 10 wt % or less, and still more preferably about 2 wt % or less, of comonomer diols in addition to the 1,3-propanediol reactant. Comonomer diols that are suitable for use in the process include aliphatic diols, for example, ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol; cycloaliphatic diols, for example, 1,4-cyclohexanediol, 1,4-cyclohexanedimethanol and isosorbide; and polyhydroxy compounds, for example, glycerol, trimethylolpropane, and pentaerythritol. A preferred group of comonomer diols is selected from the group consisting of ethylene glycol, 2-methyl-1,3-propanediol, 2,2-dimethyl-1,3-propanediol, 2,2-diethyl-1,3-propanediol, 2-ethyl-2-(hydroxymethyl)-1,3-propanediol, C₆-C₁₀ diols (such as 1,6-hexanediol, 1,8-octanediol and 1,10-decanediol) and isosorbide, and mixtures thereof. A particularly preferred diol other than 1,3-propanediol is ethylene glycol, and C₆-C₁₀ diols can be particularly useful as well.

One preferred polytrimethylene ether glycol containing comonomers is poly(trimethylene-ethylene ether) glycol such as described in US2004/0030095A1. Preferred poly(trimethylene-co-ethylene ether) glycols are prepared by acid catalyzed polycondensation of from 50 to about 99 mole % (preferably from about 60 to about 98 mole %, and more preferably from about 70 to about 98 mole %) 1,3-propanediol and up to 50 to about 1 mole % (preferably from about 40 to about 2 mole %, and more preferably from about 30 to about 2 mole %) ethylene glycol.

Suitable polytrimethylene ether glycols can contain small amounts of other repeat units, for example, from aliphatic or aromatic diacids or diesters, such as described in U.S. Pat. No. 6,608,168. This type of polytrimethylene ether glycol can also be called a “random polytrimethylene ether ester”, and can be prepared by polycondensation of 1,3-propanediol reactant and about 10 to about 0.1 mole % of aliphatic or aromatic diacid or esters thereof, such as terephthalic acid, isophthalic acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, and combinations thereof, and dimethyl terephthalate, bibenzoate, isophthlate, naphthalate and phthalate; and combinations thereof. Of these, terephthalic acid, dimethyl terephthalate and dimethyl isophthalate are preferred.

The polytrimethylene ether glycols preferred for use herein generally have a number average molecular weight from about 200 to about 10000, more preferably from from about 250 to about 5000, even more preferably from about 250 to 4000, and still more preferably from about 300 to about 3000. In some embodiments, however, the polytrimethylene ether glycols can have molecular weights of about 500 to about 5000.

The polytrimethylene ether glycols preferred for use herein are typically polydisperse polymers having a polydispersity of preferably from about 1.0 to about 2.2, more preferably from about 1.2 to about 2.0, and still more preferably from about 1.2 to about 1.8.

Blends of polytrimethylene ether glycols also can be used. For example, the polytrimethylene ether glycol can comprise a blend of a higher and a lower molecular weight polytrimethylene ether glycol, preferably wherein the higher molecular weight polytrimethylene ether glycol has a number average molecular weight of from about 2000 to about 4000, and the lower molecular weight polytrimethylene ether glycol has a number average molecular weight of from about 150 to about 500.

The polytrimethylene ether glycols for use in the present invention preferably have a color value of less than about 100 APHA, and more preferably less than about 50 APHA.

Polytrimethylene ether glycol as described above preferably has a relatively low acute oral toxicity, and is not a skin or eye irritant, or a skin sensitizer.

### Other Isocyanate-Reactive Compounds

As indicated above, the PO3G may be blended with other polyfunctional isocyanate-reactive compounds, most notably oligomeric and/or polymeric polyols.

Suitable polyols contain at least two hydroxyl groups, and preferably have a molecular weight of from about 60 to about 6000. Of these, the polymeric polyols are best defined by the number average molecular weight, and can range from about 200 to about 6000, preferably from about 300 to about 3000, and more preferably from about 500 to about 2500. The molecular weights can be determined by hydroxyl group analysis (OH number).

Examples of polymeric polyols include polyesters, polyethers, polycarbonates, polyacetals, poly(meth)acrylates, polyester amides, polythioethers, and mixed polymers such as a polyester-polycarbonates where both ester and carbonate linkages are found in the same polymer. Also included are seed/vegetable-based polyols. A combination of these polymers can also be used. For examples, a polyester polyol and a poly(meth)acrylate polyol may be used in the same polyurethane synthesis.

Suitable polyester polyols include reaction products of polyhydric, preferably dihydric alcohols to which trihydric alcohols may optionally be added, and polybasic (preferably dibasic) carboxylic acids. Instead of these polycarboxylic acids, the corresponding carboxylic acid anhydrides or polycarboxylic acid esters of lower alcohols or mixtures thereof may be used for preparing the polyesters.

The polycarboxylic acids may be aliphatic, cycloaliphatic, aromatic and/or heterocyclic or mixtures thereof and they may be substituted, for example, by halogen atoms, and/or unsaturated. The following are mentioned as examples: succinic acid; adipic acid; suberic acid; azelaic acid; sebacic acid; 1,12-dodecyldioic acid; phthalic acid; isophthalic acid; trimellitic acid; phthalic acid anhydride; tetrahydrophthalic acid anhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

Suitable polyhydric alcohols include, e.g., ethylene glycol; propylene glycol(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; diethylene glycol, triethylene glycol; tetraethylene glycol; polyethylene glycol; dipropylene glycol; polypropylene polyol; dibutylene glycol and polybutylene glycol; glycerine; trimethylolpropane; ether glycols thereof; and mixtures thereof. The polyester polyols may also contain a portion of carboxyl end groups. Polyesters of lactones, for example, epsilon-caprolactone, or hydroxycarboxylic acids, for example, omega-hydroxycaproic acid, may also be used.

Preferable polyester diols for blending with PO3G are hydroxyl-terminated poly(butylene adipate), poly(butylene succinate), poly(ethylene adipate), poly(1,2-proylene adipate), poly(trimethylene adipate), poly(trimethylene succinate), polylactic acid ester diol and polycaprolactone diol. Other hydroxyl terminated polyester diols are copolyethers comprising repeat units derived from a diol and a sulfonated dicarboxylic acid and prepared as described in U.S. Pat. No. 6,316,586. The preferred sulfonated dicarboxylic acid is 5-sulfo-isophthalic acid, and the preferred diol is 1,3-propanediol.

Suitable polyether polyols are obtained in a known manner by the reaction of starting compounds that contain reactive hydrogen atoms with alkylene oxides such as ethylene oxide, propylene oxide, butylene oxide, tetrahydrofuran, styrene oxide, epichlorohydrin or mixtures of these. Suitable starting compounds containing reactive hydrogen atoms include the polyhydric alcohols set forth above and, in addition, water, methanol, ethanol, glycerine, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- and 1,1,2-tris-(hydroxylphenyl)-ethane, dimethylolpropionic acid or dimethylolbutanoic acid.

Polyethers that have been obtained by the reaction of starting compounds containing amine compounds can also be used. Examples of these polyethers as well as suitable polyhydroxy polyacetals, polyhydroxy polyacrylates, polyhydroxy polyester amides, polyhydroxy polyamides and polyhydroxy polythioethers, are disclosed in U.S. Pat. No. 4,701,480.

Polycarbonates containing hydroxyl groups include those known, per se, such as the products obtained from the reaction of diols such as propanediol-(1,3), butanediol-(1,4) and/or hexanediol-(1,6), diethylene glycol, triethylene glycol or tetraethylene glycol, and polyether diols with phosgene, diarylcarbonates such as diphenylcarbonate, dialkylcarbonates such as diethylcarbonate or with cyclic carbonates such as ethylene or propylene carbonate. Also suitable are polyester carbonates obtained from the above-mentioned polyesters or polylactones with phosgene, diaryl carbonates, dialkyl carbonates or cyclic carbonates.

Polycarbonate diols for blending are preferably selected from the group consisting of polyethylene carbonate diol, polytrimethylene carbonate diol, polybutylene carbonate diol and polyhexylene carbonate diol.

Poly(meth)acrylates containing hydroxyl groups include those common in the art of addition polymerization such as cationic, anionic and radical polymerization and the like. Examples are alpha-omega diols. An example of these type of diols are those which are prepared by a “living” or “control” or chain transfer polymerization processes which enables the placement of one hydroxyl group at or near the termini of the polymer. US6248839 and US5990245 have examples of protocol for making terminal diols. Other di-NCO reactive poly(meth)acrylate terminal polymers can be used. An example would be end groups other than hydroxyl such as amino or thiol, and may also include mixed end groups with hydroxyl.

Polyolefin diols are available from Shell as KRATON LIQUID L and Mitsubishi Chemical as POLYTAIL H.

Silicone polyols are well known, and representative examples are described in U.S. Pat. No. 4,64,7643.

In some applications, polyols from seed/vegetable oils may be the preferred blending component because of their biological origin and biodegradability. Examples of seed/vegetable oils used for making such polyols include but are not limited to sunflower oil, canola oil, rapeseed oil, corn oil, olive oil, soybean oil, castor oil and mixtures thereof. These oils are either partial or fully hydrogenated. Polyols from such oils are disclosed, for example, in WO2004096882 and U.S. Pat. No. 4,543,369. Commercially available examples of such vegetable oil-based polyols include Soyol R2-052-G (Urethane Soy Systems), Pripol 2033 (Uniqema), Cargill Polyol-01 and Cargill Polyol-02

Similar NCO reactive materials can be used as described for hydroxy containing compounds and polymers, but which contain other NCO-reactive groups. Examples would be dithiols, diamines, thioamines, and even hydroxythiols and hydroxylamines. These can either be compounds or polymers with the molecular weights or number average molecular weights as described for the polyols. These alternatives, however, tend to be less preferred.

In order to form stable foams, it is preferred that polyurethanes have a crosslinked or gelled structure. For the present invention, this structure may be achieved by using isocyanate-reactive compound with an average nominal isocyanate-reactive (hydroxyl) functionality greater than 2. This is preferably achieved by including in the isocyanate-reactive ingredients a tri or higher-functional polyol or mixture of polyols.

Examples of higher functional polyols include those having previously been described for the preparation of the polyester polyols and polyether polyols, including but not limited to glycerin, pentaerythritol and trimethylolpropane. In one embodiment, the aforementioned polyols from seed/vegetable oils having an average hydroxyl functionality greater than 2 are preferred.

### Polyisocyanate Component

Suitable polyisocyanates are those that contain aromatic, cycloaliphatic and/or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well.

Diisocyanates are preferred, and any diisocyanate useful in preparing polyurethanes and/or polyurethane-ureas from polyether polyols, diols and/or amines can be used in this invention.

Examples of suitable diisocyanates include, but are not limited to, 2,4-toluene diisocyanate (TDI); 2,6-toluene diisocyanate; 80/20 TDI, which is a blend comprising 80 percent of the 2,4 isomer of TDI and 20 percent of the 2,6 isomer of TDI; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODI); dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are preferred.

Small amounts, preferably less than about 10 wt % based on the weight of the diisocyanate, of monoisocyanates or polyisocyanates can be used in mixture with the diisocyanate. Examples of useful monoisocyanates include alkyl isocyanates such as octadecyl isocyanate and aryl isocyanates such as phenyl isocyanate. An example of a polyisocyanate is triisocyanatotoluene HDI trimer (Desmodur 3300), and polymeric MDI (Mondur MR and MRS).

The isocyanates react with the isocyanate-reactive compound(s) to form the urethane chains within the foam, and with the water to create gas within the foam.

The isocyanate index of the composition is preferably from about 100 to about 500, more preferably from about 105 to about 350, and still more preferably from about 110 to about 300.

### Blowing Agents

Typically, organic blowing agents can be used Suitable organic blowing agents include chlorofluorocarbons (CFC's), hydrochlorofluorcarbons (HCFC's), hydrofluorocarbons (HFC's), hydrocarbons, chlorocarbons, acetone, methyl formate and carbon dioxide. However, the use of CFCs and methylene chloride in the foam is generally discouraged because of the harmful effect these materials have on the environment. More recently, hydrofluorocarbons (HFCs) and hydrofluoroolefins (HFOs) are increasingly used as blowing agents for polyurethane foams because of improved environmental properties. An example of an HFC used in making closed-cell insulating foams is HFC-245fa (1,1,1,3,3-pentafluoropropane); an example of an HFO used in making closed-cell insulating foams is cis-1,1,1,4,4,4-hexafluoro-2-butene.

Water can also be included as a blowing agent. Water functions as a blowing agent by reacting with a portion of the isocyanate to produce carbon dioxide gas.

### Other Ingredients

Ingredient formulations for the foams can include a catalyst. Catalysts are generally classified as either blowing catalysts or gelling catalysts, but some catalysts may act as both the blowing catalyst and the gelling catalyst. Blowing catalysts are generally tertiary amines and primarily catalyze the blowing reaction that creates porosity in the foam. Examples of suitable blowing catalysts include: trimethylamine, triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, dimethylethanolamine, tetramethylpropanediamine, methyltriethylenediamine, 2,4,6-tri(dimethylaminomethyl)phenol, dimethylamino pyridine, dimethyl aminoethanol, N,N′, N″-tris(dimethylaminopropyl)-sym-hexahydrotriazine, 2-(2-dimethylaminoethoxy)ethanol, tetramethyl propanediamine, trimethylaminoethylethanolamine, dimorpholinodiethylether (DMDEE), N-methylimidazole, dimethylethylethanolamine, methyl triethylenediamine, N-methylmorpholine, and mixtures thereof.

Gelling catalysts are generally organo-tin catalysts and primarily catalyze the gelling reaction that creates the urethane chains within the foam. Examples of preferred gelling catalysts include: stannous or stannic compounds, stannous salts of carboxylic acids, stannous acylate, trialkyltin oxide, dialklyltin dihalide, dialkyltin oxide, dibutyltin dilaurate, dibutyltin diacetate, diethyltin diacetate, dihexyltin diacetate, di-2-ethylhexyltin oxide, dioctyltin dioxide, stannous octoate, stannous oleate, and mixtures thereof.

Another class of preferred catalysts is alkali metal or alkaline earth metal carboxylate salts. The salt may be a salt of any metal of Group IA and IIA of the periodic table, but in general the alkali metal salts like sodium or potassium, especially potassium, are preferred.

Total catalyst levels in the formulation, when used, preferably may range between about 0.01 pph (weight parts per hundred) and about 10 pph based on the total amount of ingredients. More preferably the levels will range between about 0.05 pph and about 1 pph, and most preferably between about 0.1 pph and about 0.5 pph.

Other optional ingredients for use in the foam formulations include antioxidants, surfactants, fire retardants, smoke suppressants, UV stabilizers, colorants, microbial inhibitors, fillers, and mold release agents.

### Foam Preparation

In the process of making a polyurethane foam, the polyol(s), polyisocyanate and other components are contacted, thoroughly mixed and permitted to expand and cure into a cellular polymer. The particular mixing apparatus is not critical, and various types of mixing head and spray apparatus are conveniently used. It is often convenient, but not necessary, to preblend certain of the raw materials prior to reacting the polyisocyanate and active hydrogen-containing components. For example, it is often useful to blend the polyol(s), blowing agent, surfactant(s), catalyst(s) and other components except for polyisocyanates, and then contact this mixture with the polyisocyanate. Alternatively, all the components may be introduced individually to the mixing zone where the polyisocyanate and polyol(s) are contacted. It is also possible to prereact all or a portion of the polyol(s) with the polyisocyanate to form a prepolymer.

One aspect is for a rigid, closed-celled polyurethane foam. It is prepared by contacting an organic polyisocyanate with an active hydrogen-containing compound in the presence of the blowing agent composition characterized in that the so-prepared foam contains within its cells gaseous blowing agents.

The composition and processes are applicable to the production of a variety of expanded polyurethane and polyisocyanurate foams, including, for example, integral skin, RIM and flexible foams, and in particular rigid closed-cell polymer foams useful in spray insulation, as pour-in-place appliance foams, or as rigid insulating board stock and laminates.

The foams preferably have a density from about 15 to about 150 kg/m³, more preferably from about 15 to about 55 kg/m³, and most preferably from about 25 to about 50 kg/m³.

### EXAMPLES

The present invention is further illustrated in the following Examples. It should be understood that these Examples, while indicating preferred embodiments, are given by way of illustration only. From the above discussion and these Examples, one skilled in the art can ascertain the preferred features, and without departing from the spirit and scope thereof, can make various changes and modifications to adapt it to various uses and conditions.

Polyol A is an aromatic polyester polyol (Stepanpol PS2502-A) purchased from STE-PAN Inc. at 22W Frontage Road, Northfield, Ill. Polyol A has viscosity of 3,000 centipoise at 25° C. The content of hydroxyl groups in Polyol A is equivalent to 249 mg KOH per gram of Polyol A.

Polyol B is polytrimethylene ether glycol (Cerenol™ H650) from DuPont at Wilmington, Del. Polyol B has viscosity of 143 centipoise at 40° C. The content of hydroxyl groups in Polyol B is equivalent to 160 mg KOH per gram of Polyol B.

Polyol C is a trifunctional db Castor Oil which is obtained from Vertellus Specialty Chemicals. Polyol C has viscosity of 720 centipoise at 25° C. The content of hydroxyl groups in Polyol C is equivalent to 164 mg KOH per gram of Polyol C.

Silicon type surfactant is a polysiloxane (Dabco DC193) purchased from Air Products Inc. at 7201 Hamilton Blvd, Allentown Pa. 18195.

Potassium catalyst (Potassium HEX-CEM 977) contains 25 wt % diethylene glycol and 75 wt % potassium 2-ethylhexanoate, and is purchased from OMG Americas Inc. at 127 Public Square, 1500 Key Tower, Cleveland, Ohio 44114.

Amine based catalyst (Dabco TMR-30) is Tris-2,4,6-(dimethylaminomethyl)phenol purchased from Air Products Inc. at 7201 Hamilton Blvd, Allentown Pa. 18195.

Polymethylene polyphenyl isocyanate (PAPI 580N) is purchased from Dow Chemicals, Inc. at Midland, Mich., 49641-1206.

Hydrofluorocarbon (HFC) blowing agent is 1,1,1,3,3-pentafluoropropane from DuPont at Wilmington, Del.

Hydrofluoroolefin (HFO) blowing agent is cis-1,1,1,4,4,4-hexafluoro-2-butene from Du-Pont at Wilmington, Del.

Initial R-value is measured by a LaserComp FOX 304 Thermal Conductivity Meter at a mean temperature of 75° F. The unit of R-value is ft²-hr-°F./BTU-in.

The Examples illustrate that foams can be obtained, according to the invention, having properties comparable to those of conventional foams (shown in the Comparative Example).

### Comparative Example 1

### Rigid Polyurethane Foam Made from the Foam-Forming Composition Containing 100% Polyol A Using Hydrofluorocarbon (HFC) blowing agent 1,1,1,3,3-pentafluoropropane

Polyol A, surfactant, catalyst, and 1,1,1,3,3-pentafluoropropane were pre-mixed by hand and then mixed with the polyisocyanate. The resulting mixture was poured into a 8″×8″×2.5″ paper box to form the polyurethane foam. The formulation and properties of the foam are shown in Tables 1A and 1 B below.

TABLE 1A
Foam formulation - 100% Polyol A

| Component | Parts by weight |
|---|---|
| Polyol A | 100 |
| Silicon type surfactant | 6.17 |
| Potassium catalyst | 2.75 |
| Amine based catalyst | 0.68 |
| HFC blowing agent | 32.41 |
| Polymethylene polyphenyl isocyanate | 158.2 |

TABLE 1B
Polyurethane foam properties

| | |
|---|---|
| Foam Index | 2.5 |
| Cream time (second) | 12 |
| Rise time (seconds) | 110 |
| Tack free time (seconds) | 120 |
| Foam density (pounds-per-cubic-feet) | 2.2 |
| Initial R-value (ft²-hr-° F./BTU-in) | 7.2 |

### Example 2

### Rigid Polyurethane Foam Made from the Foam-Forming Composition Containing 80% Polyol A and 20% Polyol B

Rigid Polyisocyanurate Foam was made using 20% Polyol B by weight in the same way as described in Comparative Example 1. The foam formulation and properties are shown in Tables 2A and 2B below. Using a foam-forming composition comprising 20% Polyol B, the foam showed equally good cell structure and dimensional stability, with improved R-value.

TABLE 2A
Foam formulation - 80% polyol A and 20% Polyol B

| Component | Parts by weight |
|---|---|
| Polyol A | 80 |
| Polyol B | 20 |
| Silicon type surfactant | 6.17 |
| Potassium catalyst | 2.75 |
| Amine based catalyst | 0.68 |
| HFO blowing agent | 39.67 |
| Polymethylene polyphenyl isocyanate | 158.2 |

TABLE 2B
Polyurethane foam properties

| | |
|---|---|
| Foam Index | 2.4 |
| Cream time (second) | 12 |
| Rise time (seconds) | 80 |
| Tack free time (seconds) | 100 |
| Foam density (pounds-per-cubic-feet) | 2.4 |
| Initial R-value (ft²-hr-° F./BTU-in) | 7.7 |

### Example 3

### Rigid Polyurethane Foam Made from the Foam-Forming Composition Containing 60% Polyol A and 40% Polyol B

Rigid Polyisocyanurate Foam was made using 40% Polyol B by weight in the same way as described in Comparative Example 1. The foam formulation and properties are shown in Tables 3A and 3B below. Using a foam-forming composition comprising 40% Polyol B, the foam showed equally good cell structure and dimensional stability, with improved in R-value.

TABLE 3A
Foam formulation - 60% polyol A and 40% Polyol B

| Component | Parts by weight |
|---|---|
| Polyol A | 60 |
| Polyol B | 40 |
| Silicon type surfactant | 6.17 |
| Potassium catalyst | 2.75 |
| Amine based catalyst | 0.68 |
| HFO blowing agent | 39.67 |
| Polymethylene polyphenyl isocyanate | 139 |

TABLE 3B
Polyurethane foam properties

| | |
|---|---|
| Foam Index | 2.5 |
| Cream time (second) | 10 |
| Rise time (seconds) | 85 |
| Tack free time (seconds) | 95 |
| Foam density (pounds-per-cubic-feet) | 2.3 |
| Initial R-value (ft²-hr-° F./BTU-in) | 7.9 |

### Example 4

### Rigid Polyurethane Foam Made from the Foam-Forming Composition Containing 40% Polyol A and 60% Polyol B

Rigid Polyisocyanurate Foam was made using 60% Polyol B by weight in the same way as described in Comparative Example 1. The foam formulation and properties are shown in Tables 4A and 4B below. Using a foam-forming composition comprising 60% Polyol B, the foam showed equally good cell structure and dimensional stability, with equivalent R-value.

TABLE 4A
Foam formulation - 40% polyol A and 60% Polyol B

| Component | Parts by weight |
|---|---|
| Polyol A | 40 |
| Polyol B | 60 |
| Silicon type surfactant | 6.17 |
| Potassium catalyst | 2.2 |
| Amine based catalyst | 0.54 |
| HFC blowing agent | 32.41 |
| Polymethylene polyphenyl isocyanate | 126.5 |

TABLE 4B
Polyurethane foam properties

| | |
|---|---|
| Foam Index | 2.5 |
| Cream time (second) | 7 |
| Rise time (seconds) | 80 |
| Tack free time (seconds) | 105 |
| Foam density (pounds-per-cubic-feet) | 2.3 |
| Initial R-value (ft²-hr-° F./BTU-in) | 7.1 |

### Example 5

### Rigid Polyurethane Foam Made from the Foam-Forming Composition Containing 20% Polyol A and 80% Polyol B

Rigid Polyisocyanurate Foam was made using 80% Polyol B by weight in the same way as described in Comparative Example 1. The polyisocyanurate foam formulation and properties are shown in Tables 5A and 5B below. Using a foam-forming composition comprising 80% Polyol B, the foam showed equally good cell structure and dimensional stability, with equivalent R-value.

TABLE 5A
Foam formulation - 20% polyol A and 80% Polyol B

| Component | Parts by weight |
|---|---|
| Polyol A | 20 |
| Polyol B | 80 |
| Silicon type surfactant | 6.17 |
| Potassium catalyst | 2.2 |
| Amine based catalyst | 0.54 |
| HFC blowing agent | 32.41 |
| Polymethylene polyphenyl isocyanate | 115 |

TABLE 5B
Polyurethane foam properties

| | |
|---|---|
| Foam Index | 2.5 |
| Cream time (second) | 7 |
| Rise time (seconds) | 70 |
| Tack free time (seconds) | 95 |
| Foam density (pounds-per-cubic-feet) | 2.7 |
| Initial R-value (ft²-hr-° F./BTU-in) | 7.2 |

### Example 6

### Rigid Polyurethane Foam Made from the Foam-Forming Composition Containing 100% Polyol B

Rigid Polyisocyanurate Foam was made using 100% polyol B by weight in the same way as described in Comparative Example 1. The foam formulation and properties are shown in Tables 6A and 6B below. Using a foam-forming composition comprising 100% Polyol B, the foam showed equally good cell structure and dimensional stability, with equivalent R-value.

TABLE 6A
Foam formulation - 100% Polyol B

| Component | Parts by weight |
|---|---|
| Polyol B | 100 |
| Silicon type surfactant | 6.17 |
| Potassium catalyst | 2.75 |
| Amine based catalyst | 0.68 |
| HFO blowing agent | 39.67 |
| Polymethylene polyphenyl isocyanate | 168 |

TABLE 6B
Polyurethane foam properties

| | |
|---|---|
| Foam Index | 4.0 |
| Cream time (second) | 9 |
| Rise time (seconds) | 97 |
| Tack free time (seconds) | 120 |
| Foam density (pounds-per-cubic-feet) | 2.8 |
| Initial R-value (ft²-hr-° F./BTU-in) | 6.6 |

### Example 7

### Rigid Polyurethane Foam Made from the Foam-Forming Composition Containing 60% polyol A and 20% Polyol B, and 20% Polyol C.

Rigid Polyisocyanurate Foam was made using 60% Polyol A, 20% Polyol B, and 20% Polyol C by weight in the same way as described in Comparative Example 1. The foam formulation and properties are shown in Tables 7A and 7B below. Using a foam-forming composition comprising a 50/50 blend of Polyol B and Polyol C, the foam showed equally good cell structure and dimensional stability, with equivalent R-value.

TABLE 7A
Foam formulation - 60% polyol A, 20% Polyol B, 20% Polyol C

| Component | Parts by weight |
|---|---|
| Polyol A | 60 |
| Polyol B | 20 |
| Polyol C | 20 |
| Silicon type surfactant | 6.17 |
| Potassium catalyst | 2.75 |
| Amine based catalyst | 0.68 |
| HFO blowing agent | 39.67 |
| Polymethylene polyphenyl isocyanate | 219.4 |

TABLE 7B
Polyurethane foam properties

| | |
|---|---|
| Foam Index | 4.0 |
| Cream time (second) | 8 |
| Rise time (seconds) | 133 |
| Tack free time (seconds) | 190 |
| Foam density (pounds-per-cubic-feet) | 2.6 |
| Initial R-value (ft²-hr-° F./BTU-in) | 7.0 |

What is claimed is:

1. A closed-cell polyurethane foam comprising the reaction product of ingredients comprising:
(b) an isocyanate-reactive compound comprising a polytrimethylene ether glycol;
(b) a polyisocyanate component comprising an isocyanate; and
(c) a blowing agent.

2. The polyurethane foam of claim 1, wherein the isocyanate index of the ingredients is from about 100 to about 500.

3. The polyurethane foam of claim 1, wherein the isocyanate index of the ingredients is from about 100 to about 400.

4. The polyurethane foam of claim 1, wherein the blowing agent is selected from the group consisting of chlorofluorocarbons, hydrochlorofluorcarbons, hydrofluorocarbons, hydrofluoroolefins, hydrocarbons, chlorocarbons, acetone, methyl formate and carbon dioxide.

5. The polyurethane foam of claim 1, wherein the blowing agent comprises water.

6. The polyurethane of claim 1, wherein the blowing agent comprises carbon dioxide gas.

7. The polyurethane foam of claim 1, wherein the isocyanate-reactive compound comprises a blend of polytrimethylene ether glycol and at least one second polyol.

8. The polyurethane foam of claim 1 wherein from about 1 to 99 weight % of the total combined weight of the isocyanate-reactive compound is polytrimethylene ether glycol.

9. The polyurethane foam of claim 7 wherein the isocyanate-reactive compounds have an average hydroxyl functionality less than 9.

10. The polyurethane foam of claim 7 wherein the second polyol comprises a vegetable oil based polyol.

11. The polyurethane foam of claim 10 wherein from 5 to 90 weight % of the isocyanate-reactive compounds is vegetable oil polyol.

12. The polyurethane foam of claim 1 wherein the polytrimethylene ether glycol is made by polycondensation of 1,3-propanediol that is produced by a fermentation process using a renewable biological source.

13. The polyurethane foam of claim 1 wherein the number average molecular weight of the polytrimethylene ether glycol is from about 250 to about 4,000.

14. The polyurethane foam of claim 1 wherein the polytrimethylene ether glycol is blended with up to 95 weight %, based on the total weight of the polyols, of one or more selected from other polyether polyols and polyester polyols.

15. The polyurethane foam of claim 12 wherein the other polyether polyol—is selected from the group consisting of polyethylene polyol, poly(1,2-propylene polyol), and combinations thereof.

16. The polyurethane foam of claim 1 having a density from about 15 to about 150 kg/m³.

17. The polyurethane foam of claim 1 having a density from about 25 to about 50 kg/m³.
